(19) United States
(12) Patent Application Publication
(10) Pub. No.: US 2003/0011466 A1
(43) Pub. Date: Jan. 16, 2003

(54) Device and method for safe transport on an object

(76) Inventors: Francis Samuel, Brte/Marne (FR); Alain Richard, Paris (FR); Philippe Legorjus, Treillieres (FR); Philippe Laurent, Lyon (FR); Benito-Jean Caradonna, Coubron (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/204,072

(22) PCT Filed: Feb. 15, 2001
(86) PCT No.: PCT/FR01/00445

(30) Foreign Application Priority Data
Feb. 16, 2000 (FR) 00 01887

(51) Int. Cl. G06F 7/04

(52) U.S. Cl. 340/5.73; 340/568.7

(57) ABSTRACT

The invention relates to a device (2) for the secure transportation of an object (3), characterized in that it comprises:

means (4, 6) for containing an object (3) to be transported, also known as a container, and closure means (6, 8, 10, 14) for closing said means (4, 6) for containing an object or container,

communication means (16, 18) for connecting the means for containing an object or container to a communication network and for sending over said communication network a signal relating to a state of the means for containing said object or container, and

receiver means (16, 18) for receiving a signal for opening closure means for closing the means for containing the object.

### TECHNICAL FIELD AND PRIOR ART

The invention relates to the secure transportation of objects, for example cash (especially banknotes) and/or cheques and/or valuable or confidential documents.

It can also be applied to the transportation of valuable merchandise, for example merchandise that is intended for industrial processing, for example industrial diamonds, or rare materials.

It is applied generally to the transportation of any kind of materials, documents or information requiring, for one reason or another, to be transported from one point to another, or from one person to another, with a particular degree of security.

Armored vehicles are currently employed for this type of secure transportation, for example to transfer banknotes from a strongroom to a bank or from one banking facility to another banking facility.

Clearly this type of transportation is subject to a number of constraints, such as the necessity to book the services of, or to possess and operate, an armored vehicle and to provide physical protection for the personnel concerned.

What is more, using armored vehicles is costly and thus incurs high costs for those who must use them.

Finally, armored vehicles are generally large.

The problem therefore arises of finding a transportation method and device that are capable of providing a particular degree of security while allowing conveyance by less costly or smaller means than armored vehicles.

### SUMMARY OF THE INVENTION

The invention provides a device for the secure transportation of an object, said device comprising:

means for containing an object to be transported, also referred to as a container, and means for closing or locking said means or said container, and

communication or connection means for connecting the means for containing an object or the container to a communication network.

Accordingly, after connecting the container to the communication network, it is possible to send a signal relating to the state of the means for containing said object to another entity (for example to a monitoring or remote monitoring system).

The container may then receive in response a signal for opening the container or the means for containing said object.

The invention also provides a device for the secure transportation of an object, which device comprises:

means for containing an object to be transported, also known as a container, and closure means for closing said means for containing an object or container,

communication means for connecting the means for containing an object or container to a communication network and for sending over the communication network a signal relating to a state of the means for containing said object or container, and

receiver means for receiving a signal for opening the means for containing the object.

Accordingly, opening of the container or of the means that contain the object may be conditional on the state of said means or said container. If the signal relating to the state of the container indicates an attempt to break into the container, no opening signal is sent and manual intervention, for example by the sender, is required to open the container.

If the signal indicates a normal state of the container, the container may be opened after receiving the signal that authorizes opening. This operation is referred to as remote opening.

The secure transportation device of the invention therefore provides for remote monitoring of the state of the container, either by the sender or by a third party appointed by the sender to monitor the transportation of the container and the object to the intended destination or recipient.

It is possible to use containers of any size, and requiring no special recognition symbol, but the container employed is preferably compatible with manual transportation (in which case it constitutes a secure manual transportation device) or with mailing. In which case, the format of the container may be of the type used for mailing services (envelopes or parcels, for example).

In other words, the transportation device of the invention is preferably designed for manual transportation, for mailing or for delivery by a courier.

The details of the recipient may additionally be affixed to the container, especially if the container is mailed or transported by a courier.

Consequently, the transportation device of the invention advantageously replaces prior art secure transportation resources using strongboxes which must be transported by security guards, who are usually armed.

The communication means are preferably adapted to, or specially programmed to, send an encoded or encrypted signal relating to the state of the container.

Encoding or encryption adds an additional degree of security in that a third party obtaining information by monitoring the communication network used may intercept information relating to the state of the container only in an encoded or encrypted form.

The system of the invention comprises means for identifying a normal or abnormal operating state of the transportation device or its closure means and/or for identifying an attempt to break into or violate or open the transportation device or its closure means without authorization or a type of attempt to break into or violate or open the transportation device or its closure means without authorization.

Accordingly, the secure transportation device or the container may be provided with means for detecting or measuring the temperature of the atmosphere around the container and/or means for detecting or measuring the relative humidity of the atmosphere around the container.

In one embodiment, a conductive circuit is disposed inside the container with means for detecting interruption of the circuit.

A variation outside one or more specified ranges of temperature and/or relative humidity or above or below a predetermined threshold value of temperature and/or relative humidity and/or detection of interruption of the conductive circuit may trip means provided inside the container for destroying or spoiling or staining or marking an object contained in the container.

The communication means of the secure transportation device of the invention are advantageously means for connection to a telephone network.

After connection to a telephone network, the communication means of the transportation device of the invention dial a telephone number, for example that of the sender or the agency appointed to monitor transportation.

Once the call has been set up, the called party compares the telephone number of the place concerned or of the telephone jack to which the transportation device is connected to one or more predetermined numbers of the initially chosen recipient.

If the number from which the secured transportation device is calling is that of the initially chosen recipient, the container may be opened remotely, after verifying the state of the container.

The telephone network via which the call is made is preferably an analog network, because an analog network is more secure than a digital network.

In other embodiments, the communication network may be the Internet or a local area network (LAN), ETHERNET network, an integrated services digital network (ISDN), an X.25 network or any other type of network. The secure transportation device of the invention is then provided with means for sending over the network signals relating to its state or a signal or signals identifying a recipient, for example a predetermined TRANSPAC or Internet address.

When it connects to the network, the secure transportation device dials an identification number of a monitoring system or device or terminal to which the sender or an agency appointed to monitor transportation, for example, is connected.

After the connection is set up, a signal or signals relating to the state of the container is sent to a person (for example the sender or the person monitoring transportation) or to the monitoring system or device or terminal who or which is able to send an opening signal for opening the means which close or lock the container throughout its transportation. When the call has been set up, an electronic address or identification of the place concerned or of a terminal to which the transportation device is connected may be compared to a predetermined identification or address for the recipient initially chosen. If the address or identification is that of the recipient initially chosen the container may be opened remotely, after the state of the container has been verified.

According to another aspect of the invention, the secure transportation device of the invention further comprises electrical power supply means for supplying power to the connection or communication means and/or the receiver means.

Thus the device of the invention is autonomous. All that is required, before transportation commences, is to check that the electrical power supply means have sufficient capacity to send the signal corresponding to the state of the container.

The invention also provides a device for monitoring the secure transportation of an object contained in a closed container, for example a container of the invention as defined hereinabove, which monitoring device is characterized in that it comprises:

means adapted to be connected to a communication network to receive a signal relating to a state of the container, and

means for determining, or specially programmed to determine, a state of the container as a function of the signal relating to the state of the container,

means for determining, or specially programmed to determine, if an opening signal may be sent or transmitted to said container, as a function of the state of the container so determined, and

means for sending, or specially programmed to send, a signal or an opening signal to the container.

The invention further provides a system for monitoring the secure transportation of an object contained in a closed container, for example a container of the invention as defined hereinabove, which system is characterized in that it comprises:

means adapted to be connected to a communication network to receive a signal relating to a state of the container, and

means for sending, or specially programmed to send, an opening signal to the container after receiving, and as a function of, the signal relating to the state of the container.

A monitoring system as defined above provides remote monitoring of the state of a container or a secure transportation device of the invention when said device or said container is handed over to a recipient.

The monitoring system may be provided with means adapted to, or specially programmed to, send a signal for destroying or staining or potting or marking an object contained in the container if the state signal received indicates that the container has been forced or is being forced or has been attacked or is being attacked by an external agent or that the container is still closed after a predetermined period closure.

It may be advantageous, in some situations, to be able to destroy or neutralize the object contained in the container immediately if it is found, on receiving the closed container, that it has suffered an attempted attack or it is found that the container was not opened at the appointed time.

In one embodiment of the invention, the monitoring system of the invention further comprises means for arming beforehand means for destroying, staining, potting or marking an object contained in the container and for then disarming said means before the opening signal is sent.

The operation or step or arming the destruction, staining, potting or marking means may be effected immediately after loading the object into the container, for example on the premises of the monitoring system operator.

The communication network to which the monitoring system of the invention is connected may be of any of the types already referred to (a telephone network, the Internet, an Ethernet network, a LAN, an ISDN, an X.25 network, or any other type of network).

The system of the invention preferably further comprises, or is preferably further connected to, a local communication line, of a local network, for example of a local telephone network, which may be used to arm the means for destroying, staining, potting or marking an object contained in the container.

Accordingly, if the container is itself also connected to the local network, for example to the local telephone line, arming may take place without encoding the information exchanged between the monitoring system and the container.

According to another aspect of the invention, the monitoring system further comprises means for storing an identification code of a recipient or a destination of the transported object and for comparing an identification code received with said identification code of the recipient or the destination of the object.

The monitoring system then sends a signal, for example an opening signal, which allows for the identification code of the recipient or the destination of the transported object.

The invention further provides a method for the secure transportation of an object, which method comprises:

loading the object into means for containing said object and closing or locking said means, which are preferably of the type defined hereinabove in the context of the present invention,

transporting said object and the means that contain it,

connecting the means that contain the object to a communication network, and

sending over said communication network a signal relating to the state of the means that contain the object.

An opening signal is received by the means that contain the object in response to sending the signal relating to the state of the means that contain the object, especially if the signal transmitted by the container indicates that it is in a predetermined state, preferably a normal state.

In another embodiment of the invention, the above kind of method includes, before the transportation step, a preliminary step of arming means for destroying, staining or potting the object contained in the container.

The object contained in the container may then be neutralized, destroyed, stained or potted if the signal transmitted by the container indicates that the container is in a state other than the predetermined state, especially a state other than the normal state, or that the container has been forced or is being forced, or has been attacked or is being attacked, by an external agent, or that the container is still closed after a predetermined closure period.

The invention further provides a method of monitoring the secure transportation of an object contained in a closed container, which container is preferably of the typed defined hereinabove in the context of the present invention, and which method is characterized in that it comprises:

means connected to a communication network receiving a signal relating to a state of the container after connection of said container to said network, and

sending an opening signal to the container after receiving the signal relating to the state of the container, in particular if the signal relating to the state of the container corresponds to at least one predetermined type of state, or, after receiving the signal relating to the state of the container, sending a signal that is a function of or depends on said signal relating to the state of the container.

The invention further provides a method of monitoring the secure transportation of an object contained in a closed container, which method is characterized in that it comprises:

means connected to a communication network receiving a signal relating to a state of the container after connection of said container to said network,

neutralizing, destroying, staining or potting the object contained in the container if the signal relating to a state of the container sent by the container indicates that it has been, or is being, forced, violated or attacked by an external agent, or if the signal relating to a state of the container sent by the container differs from at least one predetermined signal or does not correspond to at least one predetermined signal or at least one predetermined type of signal, or if the container is still closed after a predetermined closure time.

Accordingly, either the container can be opened remotely if the state of the container is identified as being satisfactory or as conforming to a predetermined state, or the container can be neutralized if the state of the container does not correspond to a predetermined state, one that is deemed to be satisfactory.

### BRIEF DESCRIPTION OF THE DRAWINGS

The features and advantages of the invention will become clearer in the light of the following description. This description relates to embodiments provided by way of explanatory and non-limiting example and refers to the accompanying drawings, in which:

FIG. 1 represents a transportation device of the invention,

FIG. 2 represents a transportation device of the invention and a monitoring system, both of which are connected to a network,

FIG. 3 represents diagrammatically the structure of a data processing system of a monitoring system of the invention,

FIG. 4 represents a monitoring system of the invention and a plurality of transportation devices connected to said monitoring system by networks or local links,

FIGS. 5A and 5B represent another embodiment of a transportation device of the invention,

FIG. 6 represents the functional architecture of communication and security control means of a secure transportation device of the invention,

FIG. 7 represents one embodiment of communication and security monitoring means of a secure transportation device of the invention, and

FIG. 8 is one example of a network architecture of one embodiment of the invention.

### DETAILED DESCRIPTION OF EMBODIMENTS OF THE INVENTION

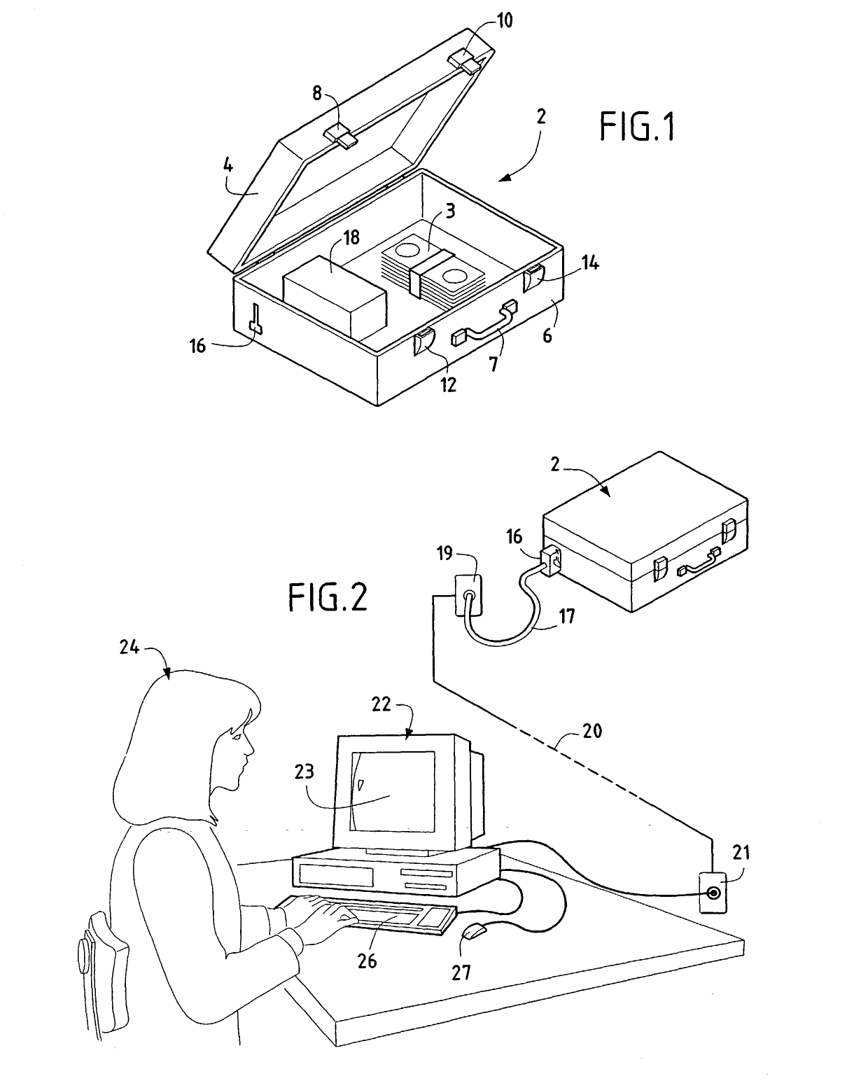

FIG. 1 represents diagrammatically a secure transportation device 2 of the invention. In the embodiment shown, this device takes the form of a case whose two parts 4, 6 can be closed by closure or locking means 8, 10, 12, 14.

The case can be used to transport cash 3 or any other merchandise which must be transported confidentially or whose transportation necessitates certain precautions.

A handle 7 enables manual transportation of the device.

The closure or locking means can be of the electromagnetic type, for example, essentially comprising a miniature solenoid. In a different embodiment, the closure or locking means essentially comprise a selectively operable mechanical device.

The device can further comprise power supply means to confer upon it some degree of autonomy, for example a compact lithium battery.

Means 16 provide a connection to a communication network and means 18 send signals to a monitoring system, which is described later, via the connection means 16, in particular signals relating to the state of the transportation device or signals identifying the place at which the device 2 is connected to the network. These means also receive signals sent by the monitoring system.

In the embodiment shown, the reference number 16 designates a jack for a connection to a network such as a telephone network and the means 18 disposed inside the transportation device are electronic means for sending or receiving signals via the connection set up with the aid of the means 16 or the jack 16.

The means 18 preferably also monitor opening and closing of the closure or locking means 8, 10, 12, 14. In other words, the closure means receive a closing or opening instruction from means disposed inside the transportation device itself.

The walls that define the transportation device of the invention can be made of flexible plastics materials, especially in the case of parcel type devices, or of a material such as rubber for devices with an “envelope” format. These types of materials are compatible with the insertion into the container of management means or a management system 18 in the form of an electronic circuit card, for example, and with the provision of a connecting jack 16 on one of the outside surfaces or walls.

For larger devices, such as cases of the type shown in FIG. 1, non-deformable materials can be used for the walls.

As indicated above, the jack 16 enables connection to a communication network. FIG. 2 shows the connection of the closed case 2 to a telephone network 20 shown diagrammatically in dashed outline. The jack 16 is used to connect the case to a telephone jack 19 by means of a cable 17.

A monitoring system 22 is also connected to the communication network 20, for example by connecting it to a telephone jack 21, as shown here. In the example shown, the monitoring system essentially comprises a microcomputer 22 provided with an interface enabling it to communicate via a telephone network, for example a modem. An operator 24 implements the monitoring function, as described later.

The monitoring system 22 comprises a display screen 23, a keyboard 26, and peripheral devices such as a mouse 27 for moving a cursor over the screen 23.

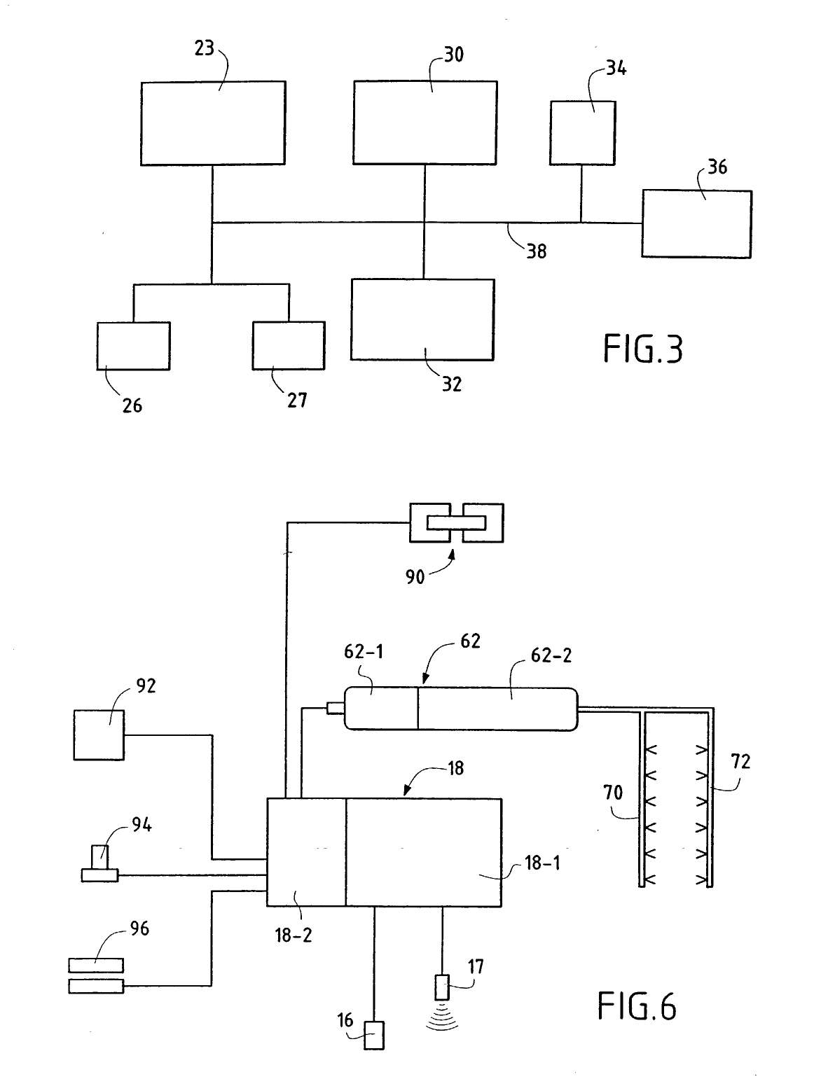

FIG. 3 is a block diagram of the components of the monitoring system 22. A microprocessor 34 is connected by a bus 38 to random access memories (RAM) 30 for storing data and to a read only memory (ROM) 32 in which monitoring program instructions are stored. The system further comprises the display screen 23 and the peripheral devices (keyboard 26 and mouse 27).

The reference number 36 designates a modem for setting up a call to a telephone network 20.

A PC can be used as the computer of the system 22 of the invention. For example, the system 22 can be based on a Pentium PC running Windows NT.

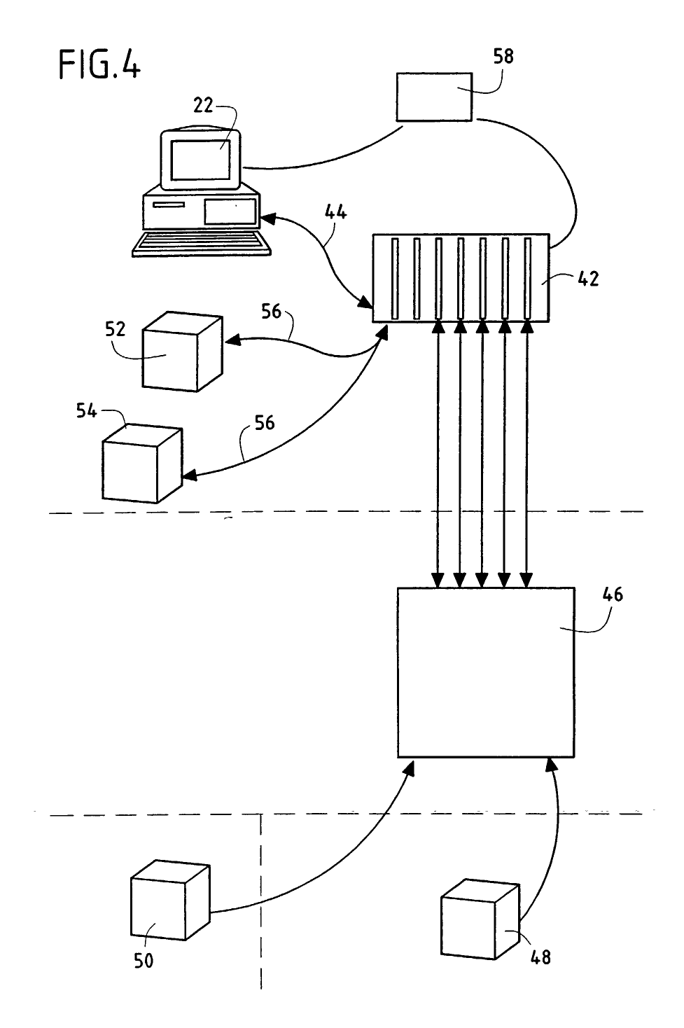

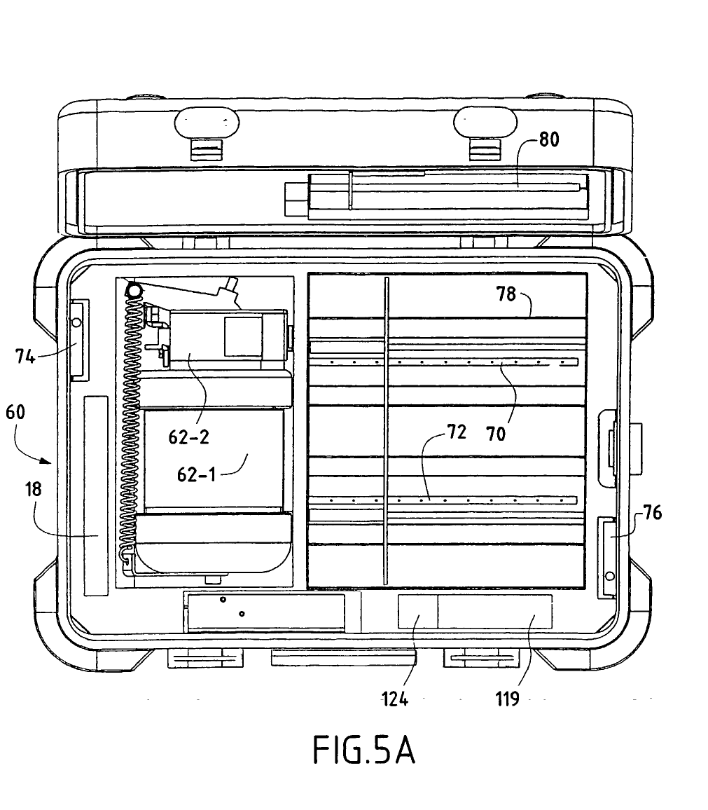

More generally, a plurality of users, that is to say a plurality of containers each transporting one or more different objects, can be connected to the monitoring system 22. FIG. 4 shows this embodiment, in which containers or transportation devices 48, 50 (represented here in the form of parcels, for example postal parcels) are connected via a communication network 46 such as a public telephone network to receiver means 42 such as a receiver center in turn connected to the monitoring system 22 by a connection 44 (for example an RS 232 connection).

A local connection can be made between containers 52, 54 on the premises of the operator of the monitoring system 22 via one or more local connection lines 56. The benefit of this type of connection is explained later.

The combination of the monitoring system 22 and the receiver means 42 is connected to electrical power supply means 58.

The description of the above system refers to a communication network in the form of a telephone line. It is also possible to use any other type of communication network employing a system for addressing equipment units or stations connected to it. For example, it is possible to use the Internet, the link being provided, for example:

at the monitoring system 22 end, by a PC fitted with a communication card, and whose address is known, and

at the recipient end, by the transportation device itself, to be more precise the electronic means 18, which comprise a programmed microprocessor and a network card (or line interface means) for the connection to the communication network, for example.

A secure transportation method using the systems described above is explained next. First of all, the object 3 to be transported is placed in the transportation device 2 and the device is closed. The means 8, 10, 12, 14 are locked so that the device 2 cannot be opened without forcing it unless opening is commanded by the monitoring system 22.

The means 8, 10, 12, 14 can be locked by any available means, but preferably by the means 16, 18 that command opening when the container is received. In this case, before shipping the container and its contents, the transportation means are connected to the system 22 a first time and the system sends a signal for closing or locking the container(s) 2, 52, 54. To avoid security problems that may arise during this step if using a public network, such as a public telephone network, this first connection is advantageously a local connection, for example a connection via a local area network such as the local lines 56 (FIG. 4): in this case communication between the monitoring system 22 and the container(s) does not need to be encoded or encrypted.

During or after this locking phase, information that will be used in the opening procedure is transmitted from the monitoring system 22 to the container 2, 52, 54.

Following its shipping and transportation, the transportation device is received by its recipient. Using the means 16, 17, 19, the recipient sets up a connection to the system 22 via the network 20.

If the container 2 is in a normal state, for example if there has not been any attempt to open it without authorization, to force it, to force the closure means 8, 10, 12, 14, or to force or destroy or interfere with the opening control means 18, the means 18 emit a signal which reflects this normal state and is received by the monitoring system 22. The operator 24, or the system 22, which is specifically programmed for this purpose, can then determine the state of the container as a function of the signal received (in this instance a normal state), and determine a signal to be sent back in response (in this instance a signal to open the container). The system 22 can then send an opening signal to the transportation device 2. This signal is received and processed by the means 18, which then send an opening instruction or command to the locking means 8, 10, 12, 14.

If the state of the device 2 indicates that it has suffered an attempt to open it without authorization, or that it has been forced or is being forced, or that the locking means 8-14 or the control means 18 have been forced or interfered with in a manner that might indicate an attempt to force them, the means 18 send a different signal, which reflects this state. The operator 24, or the system 22, which is specifically programmed for this purpose, can then determine a state of the container as a function of the signal received (in this instance an abnormal state), and determine the required response (in this instance not to send a signal for opening the container). The system 22 does not send the transportation device 2 an opening signal in this case. It can send it a signal indicating the existence of an anomaly and that it is impossible to send an opening signal, which is received and processed by the means 18, which can forward the information to a display device incorporated into the walls of the container or to a device for emitting an alarm signal.

The device 2 and its means 18 can send, or are programmed to send, a predetermined signal as a function of the state of the container or of the device 2. They can also send a signal identifying the container itself.

Similarly, the system 22 sends an opening signal if the signal received that indicates the state of the transportation device corresponds to a predetermined type of signal that an operator 24 can qualify as normal or not.

In other words, the device 2 is programmed, or specifically programmed, to send, as a function of the signal received, either an opening signal or some other type of signal (for example a signal indicating that it is impossible to send an opening signal or a signal for neutralizing the contents (see below)).

The device 2 can be programmed so that some signals that do not correspond to a completely intact state of the container are accepted or interpreted by the device 2 as representing an almost normal state; an opening signal can be sent in response to this type of signal.

The means for detecting an attempt to break into the device 2 can be the means 18 themselves, or additional means such as sensors which transmit to the device 2 or to the means 18 a signal representing a normal or abnormal variation of a particular physical parameter.

For example, the inside walls of the transportation device 2 can be provided with electrical means forming a circuit when the container is closed, this circuit being interrupted in the event of an attempt to break into the device 2, such as an attempt to separate the two parts 4, 6 of the device 2. The inside walls of the device 2 can be covered with an electrical mesh, for example, or with electrical conductors that are connected to the electronic means 18. In a normal closed state of the device 2, a current flows normally in the mesh or in the conductors and a prescribed current is detected by current detector means, disposed in the means 18, for example. If the circuit is interrupted current no longer flows and the means 18 register a change in the current. After connection to the network 20, the means 18 send a signal indicating this change.

The device 2 can further be provided with one or more sensors, such as a heat sensor for detecting an abnormal change in temperature in the environment of the device 2 or a relative humidity sensor for detecting an abnormal variation in the relative humidity in the environment of the device 2. Sensors of this kind can detect an attempt at unauthorized opening or violation using one or more sudden variations in temperature and/or by introducing a liquid around the container or the means 18 for sending signals or for controlling opening of the transportation device.

The device 2 can be attacked in other ways, for example by applying a high voltage to visible components of the device or by applying electromagnetic fields. Sensors can therefore be provided to detect variation of a voltage applied to the device 2 or variation of an electromagnetic parameter, for example a magnetic field applied in the environment of or inside the device 2.

In one example, the device is equipped with two temperature sensors, namely a first sensor for detecting temperatures below a threshold T₁ (for example −25° C. or 0° C.) and a second sensor for detecting temperatures above a threshold T₂ (for example 60° C. or 40° C.).

In another example, two protective meshes can be stuck to the device 2, namely a first mesh in the upper portion 4 and a second mesh in the lower portion 6. A potentiometer can be provided for each mesh to vary an impedance that varies as a function of the surface area of the device 2. Each potentiometer is connected to the means 18 by two soldered wires.

In a further example, a switch can be mounted directly on the device 2 to signal its opening. This switch delivers a binary indication. It is connected to the means 18 by two soldered wires.

The use of sensors, such as electrical or electromagnetic sensors (for example voltage or magnetic field sensors) or heat or relative humidity sensors, or electrical meshes, or staining or destruction or potting means, is compatible with producing a device of the invention in any of the formats already referred to hereinabove. All that is required is to select the sensors or to adapt the size of the staining or destruction or potting system to suit that of the selected transportation device.

For improved security, an identification code of a recipient or a destination of the transported object can be stored beforehand by the monitoring system 22. If the network 20 is a telephone network, this code can be the telephone number of the place to which the device 2 is to be delivered. When the device 2 is connected to the telephone network 20 via a telephone jack 19, the telephone number of the place of arrival, or which corresponds to the jack 19 to which the device has been connected, can be sent automatically to the monitoring system 22, which therefore identifies the place where the device 2 is located, or to which it has been delivered, and can therefore verify if that place corresponds to the place to which the transportation device should in fact have been delivered in the first place. It is therefore possible to add the following condition, as a condition for delivery by the system 22 of the signal for opening device 2: the identification code is that of the recipient or the destination initially intended. The connection of the system 22 to the telephone network 20 can also provide for automatically identifying the calling device 2 once it has been connected to the telephone network.

When, as already mentioned, the means 18 are designed or programmed so that they also send a signal identifying the container, the system 22 can further verify whether the intended container has been delivered to the intended recipient or destination, by checking container identification and destination data previously stored in the memory of the system 22.

Another condition for the deliverance, by the system 22, of the signal for opening the device 2 can therefore be the following condition: the container is that which is for the recipient or the destination originally intended.

To complement the protection obtained with the aid of one or other of the means already described above, the transportation device of the invention can further incorporate means for destroying and/or staining and/or potting and/or marking an object that it contains.

Thus the content of the device 2 can be rendered unusable by anyone succeeding in forcing the device 2 or opening it without authorization. For example, cash 3 can be stained, or confidential documents can be destroyed, or precious objects can be potted to form a solid mass in the event of any attempt to open the device 2.

In one embodiment, a dedicated compartment inside the device contains a product or a liquid suitable for such neutralization, such as an indelible dye for staining, a mineral acid or an organic solvent for destruction, or a synthetic resin for potting.

The transportation device is then preferably made of an impermeable material, which guarantees maximum effectiveness of neutralization the object by the neutralizing liquid or product.

The dedicated compartment that contains the neutralization product or liquid is preferably isolated from the part receiving the content to be transported by a wall, for example a polyurethane foam wall, thereby protecting it from impact during transportation and manipulation.

Means are also provided for expelling the neutralization liquid or product onto the object transported in the device 2, for example a second compartment containing a compressed gas for expelling the product.

The product is then spread uniformly over the cash, documents or objects transported, for example by spray manifolds disposed in the vicinity of the area in which the object 3 transported is located.

A staining or destruction or potting process can be tripped by means internal to the container, such as the means 18, and/or by the remote monitoring system 22.

The destruction, staining or potting means can therefore be tripped by the electronic system 18, for example on the basis of information received from one or more sensors as already described (interruption of a circuit and/or a conductive mesh and/or detection of an abnormal variation in relative humidity and/or detection of an abnormal variation in temperature and/or detection of an abnormal variation in a voltage and/or an electromechanical parameter such as a magnetic field and/or detection of an abnormal variation in any other physical parameter that may represent an attempt to break into the device 2).

The staining, destruction or potting system can be tripped by the system 22 if it detects an anomaly, for example after receiving via the network 20 a signal that represents an abnormal state of the device 2. It can also be tripped if the system 22 identifies a recipient not conforming to the recipient initially intended or a container that does not correspond to the intended recipient, even though the recipient is in fact the one originally intended.

In this case, the system 22 not only does not send an opening signal but also sends a signal or an instruction for tripping the destruction, staining or potting of the object. To be more precise, this signal is received by the means 18 which trip the destruction, staining or potting means.

When, after connection to the network 20, the means 16, 18 send the monitoring system 22 a signal reflecting a normal state of the transportation device, the system 22 sends in response:

a signal for disarming or deactivating the staining, destruction or potting means, and

a signal for opening the device 2.

In accordance with another aspect of the invention, the device 2 must be opened and its content must be removed from it within a particular time interval starting from reception of the signal authorizing its opening. Beyond this time interval, the device is locked again and/or the destruction, staining or potting means are armed or activated again.

To this end, the means 18 include a clock and, after a particular time period, the means 18 send a signal to trip locking and/or the arming system.

When the transportation device 2 has been loaded with the object 3, the device is closed and locked and the staining, destruction or potting system is then armed, where applicable. These operations are effected on the instructions of the operator 24 of the system 22, for example, by means of a connection via a local line, such as one of the lines 56 shown in FIG. 4.

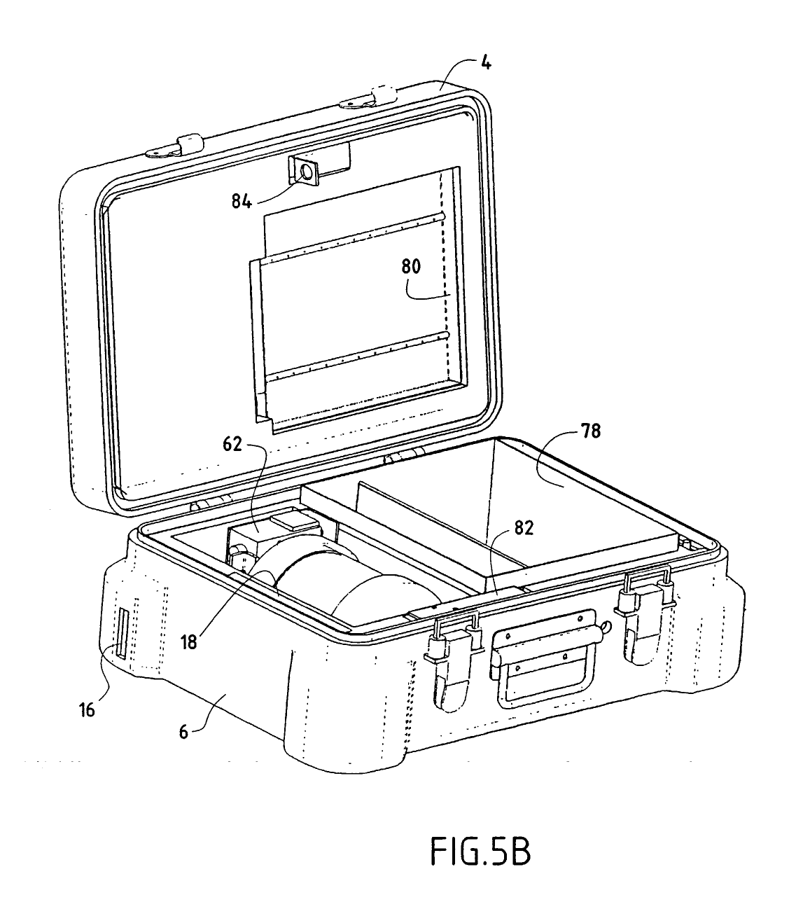

FIGS. 5A and 5B show an embodiment of a transportation device 60 of the invention which includes means for neutralizing the transported contents.

In these figures, the reference number 16 designates the jack for the connection to the network and the reference number 18 designates electronic communication and signal processing means. The reference number 62 designates the staining system connected to staining manifolds 70, 72 which are disposed at the bottom of a compartment 78 which can contain banknotes or documents. A cover 80 in the upper part 4 of the device closes the compartment 78.

Closure switches 74, 76 detect opening of the transportation device in the manner previously described, and with the same consequences.

The closure system 82, 84 operates on the principle of electromagnetic locking: the system 60 is opened or closed electrically, using a solenoid, and is connected to the electronic control system 18. The power rating of the coil of the solenoid is 3 W and the solenoid voltage is set at 6 V, for example.

Power supply means 119 and back-up battery means 124 are also represented in the wall of the case 60.

FIG. 6 shows the electronic means 18 for controlling and monitoring a secure transportation device of the invention provided with various peripheral devices.

To be more precise, the means 18 include a first subsystem 18-1 for managing communication with the monitoring system via the jack 16 and which also controls signaling means 17 for indicating a system anomaly to an external operator or transporter.

The means 18 include a second part 18-2 which manages system security and locking. In the FIG. 6 embodiment, this second part is connected to a mesh 92 in the container, a heat sensor 94, and an opening sensor 96. The means 18-2 also control opening and closing of the locking means 90 of the device.

The means 18-2 also control activation of the staining, destruction or potting system 62, with its two compartments 61-1 and 62-2 and two spray manifolds 70, 72.

The FIG. 6 diagram relates to one particular embodiment of the invention. A transportation device of the invention can also be implemented without the members 92, 94, 96 and without the staining means 62. It is then obviously less secure, but the container can be opened remotely as a function of a signal indicating the state of the device.

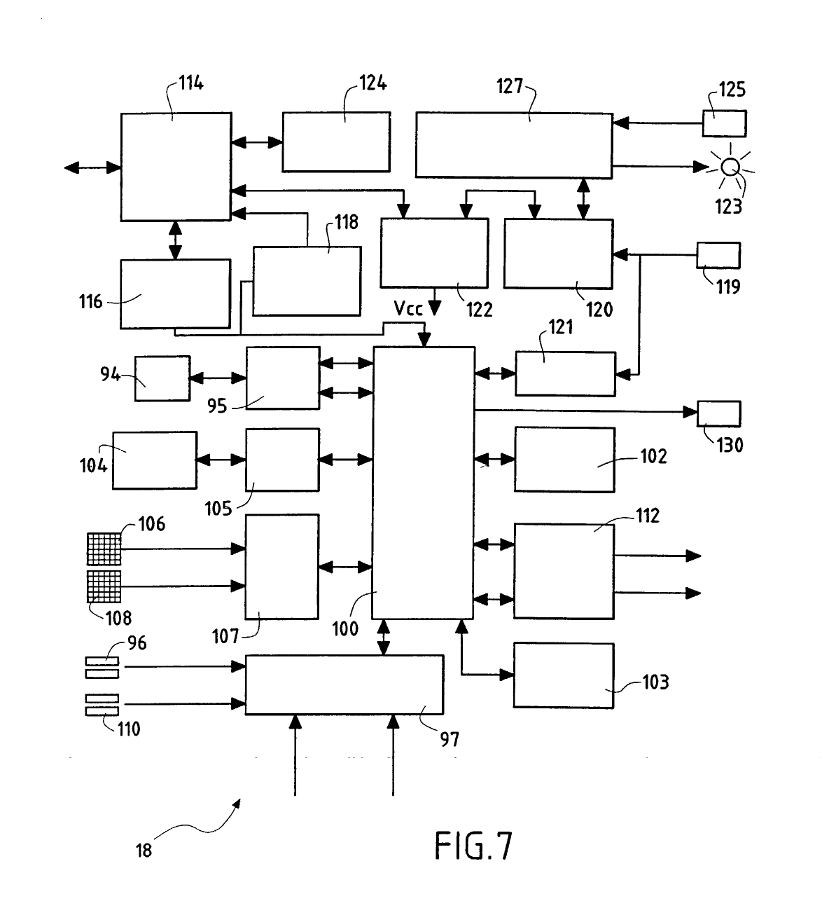

FIG. 7 shows in more detail the communication and control means 18 of a transportation device of the invention.

The components of this device are organized around a microprocessor or microcontroller 100, non-volatile memory means 102 and a clock 103.

The embodiment shown comprises the following sensors or detectors:

a temperature sensor 94,

a relative humidity sensor 104,

a protective mesh 106 in the upper part 4 of the device,

a protective mesh 108 in the lower part 6 of the device,

an opening detector 96 (opening switch), and

means 110 (empty/full switch) for detecting the presence of an object in the device.

Each sensor or detector is connected to means or to a circuit 95, 105, 107, 97 for shaping the signal emitted by the sensor or the detector. Once it has been shaped, the signal is transmitted to the microprocessor 100, which is programmed to trigger the necessary actions after receiving signals from the above sensors or detectors (sending a signal reflecting an incorrect state of the device to the monitoring system 22, triggering a signal commanding neutralization, displaying a message to a user, for example the transporter or the recipient of the object).

The microprocessor 100 also triggers opening of the locking means 8-14 (FIG. 1) or 82, 84 (FIG. 5A, 5B) or 90 (FIG. 6) by sending a signal which is shaped by a shaping circuit 112.

Communication with the monitoring system is via line interface means 114, a modem 116 and a DTMF sender 118.

In one embodiment of the invention, the modem 116 is a V.23 modem transmitting at 1 200 bauds in the container to supervisor direction and at 75 bauds in the supervisor to container direction. The choice of these values optimizes the electrical power consumption of the device.

The signals received from the monitoring system 22 pass through the jack 16, the interface 114, and the modem 116 and are forwarded to the processor 100, which is programmed to trigger the necessary actions after receiving this signal (for example, opening the transportation device, triggering neutralization (staining, potting, destruction), or displaying a message on a display screen 130 of the transportation device).

Signals sent to the monitoring system 22 by the means 18 pass through the circuit 118, the interface 114 and the jack 16.

Power supply means 119 such as a battery contained in the transportation device of the invention are also connected to the means 18, and in particular to voltage regulator means 120. These are in turn connected to power supply routing means 122 which supply a voltage V_{CC} to the microprocessor 100 and a power supply voltage to the interface circuit 114. The voltage regulator means 120 can also be connected to a charger 127 which can itself be connected to a DC charger 125 and to a diode 123 indicating the state of charge of the battery.

Finally, back-up battery means 124 can be provided to supply power to the interface 114. Thus a malfunction of the power supply of the transportation device of the invention or a reduction in the power supply voltage does not interfere with communication with the monitoring system 22.

The back-up battery means 124 also establish communication with the supervisor 22 if the battery is completely destroyed or the power supply means are completely destroyed, for example following a potting, staining or destruction operation. Thus the command for opening the device can be executed without recourse to mechanical means of the crowbar type.

FIG. 5A also shows the means 119 and 124 in position in the wall of the case 60.

The means 18 can be implemented entirely in the form of printed circuits, with the temperature and relative humidity sensors soldered to the printed circuit. The meshes 106, 108 and the opening switch 96 are connected to the electronic circuit card by soldered wires. Two soldered wires also connect the card to the means for locking the transportation device.

One embodiment of the transportation device of the invention includes means for locating it continuously during its transportation.

GPS location means can be used, for example.

In this case, the transportation device of the invention includes GPS transceiver means.

The device can therefore receive information on its location at anytime.

It is also equipped with means for sending RF signals to and receiving RF signals from the monitoring system, for example transceiver means.

The monitoring system is also equipped with transceiver means for sending and receiving RF signals. It processes signals received from the transportation device and containing information on its position, and in this way monitors its route.

If the route differs or departs from a route planned in advance, the monitoring system can send a signal to trip the means for neutralizing the transported contents.

A method according to the present invention of transporting an object is described in more detail next.

For security reasons, the transportation operation preferably begins in the premises in which the monitoring means 22 are installed.

The cash, documents or objects to be transported are loaded into the device 2, 60 or the transportation case beforehand or on the premises containing the monitoring means 22.

When the container, loaded with its contents, has been closed, the following operations are effected.

The supervisor 22 receives information concerning the recipient of the contents, for example a telephone number. This operation can be effected automatically, after dialogue with the operator's data processing system 22, or manually.

The local telephone line 56 used for programming it is connected to the container.

A telephone call is set up between the supervisor 22 and the container 2 or 60.

Confidential information that will be used when opening the container is then exchanged.

At this time the monitoring system 22 verifies the state of the battery 119 and the sensors. The corresponding information is displayed on the monitoring screen and/or on a LCD and/or stored in memory. A report is then sent to the operator's data processing system and an arming confirmation docket is printed out.

The local telephone line 56 is then disconnected and the container is handed over to the transporter.

The device can be disarmed on the premises of the client who takes delivery of the container or on the premises of the operator if a container that has not been emptied is returned to the operator. In both cases, the objective is to open the case without neutralizing the contents.

This operation is carried out under the control of the supervisor 22, after connecting the container to a predetermined specific telephone line.

The following operations are therefore carried out once a container has been received.

The container is connected to a local or direct telephone line. Connecting the container leads to automatic line seizure and the dialing of a telephone number, which in this example is the telephone number of the supervisor 22.

A call between the supervisor 22 and the container is then set up.

Information is exchanged to authorize opening of the container. Opening of the container is authorized after verifying confidential information loaded during the arming operation, including the identity of the recipient. The detection of an error can terminate the procedure for opening the container.

The authorization to open the container is then sent. It can be valid for only a particular time, for example for 10 s.

If it is not opened during this time, the container is locked again.

Otherwise, the container is opened, which can be reported immediately to the supervisor 22, for example displayed in an events table of the supervisor 22 and/or by sending a report to the operator's data processing system.

The telephone line is then disconnected.

If the container cannot be opened, the user disconnects his telephone line and starts the operation again later. This automatic redialing of the telephone number can be disabled after a particular time (for example after one minute), requiring the client or the recipient to remain in front of the container during the disarming operation.

The monitoring system 18 can be programmed to make opening impossible after a plurality of successive opening attempts (for example three attempts). The device is then returned to the operator, for example, who alone has authority to intervene.

Specific information corresponding to one or other of the above steps can be displayed on display means of the container.

In particular, the display means advise the user if the container cannot be opened.

The operations described above assume that staining, destruction or potting has not taken place. Staining, destruction or potting relates to a container that is armed, closed and not empty. If the container is not armed, closed and not empty, an anomaly is stored for logging in the supervisor 22, but this does not activate the staining or destruction command.

The neutralization command can also be triggered remotely by the supervisor 22. This enables the operator to intervene on containers that have been reported stolen.

Once opened and emptied of its contents, the container is sent back to the monitoring system, which can assign it to transporting another object to another recipient. The electronic address or identification of the new recipient can be stored in the monitoring system 22 for verifying the identity of the new recipient, after delivery and before opening.

In another embodiment of the invention, the container can be charged with another object on the premises of a first recipient and then sent directly to a second recipient without being sent back first to the monitoring system.

The procedure is then the same as that previously described, except for this difference: closure, arming the neutralization means and/or checking the state of the battery and the sensors are effected by remote control, possibly after unloading the container, and while the container is still connected to the line or to the jack 19 of the first recipient (see FIG. 1).

The new electronic address and the new identification number of the new recipient can also be transmitted during this connection.

The new destination of the container is then programmed (by entering an electronic address or code or an identification number for the new recipient).

In one embodiment of the invention, the new electronic address or identification number can be entered and stored beforehand, while preparing the container on the premises of the monitoring system operator, before shipping it to the first recipient.

In other words, several successive recipient electronic addresses or identification numbers can be entered beforehand. This avoids having to send one or more confidential identification codes over a public communication network such as a telephone network.

The means or the electronic card 18 have no identification before a container is used for the first time. A number is assigned to the container, copied into the nonvolatile memory 102 of the card 18, and added to a database maintained by the supervisor 24, possibly with the container connected to a local line 56 (FIG. 4). This operation can also be used to associate a given container with the name of a given operator 24 and thereby prohibit use with the supervisory system 22 of any other operator. The identification data can be part of the data sent by the container to the supervisory system 22 after it is received by a recipient and connected to the network on the premises of the recipient. The data is first verified (is the sending container authorized to work with the supervisor contacted?), after which the system 22 carries out the verification operations already explained hereinabove (verification of the state of the container and possibly verification of the identity of the recipient).

Accordingly, a system of the invention initializes each of the containers that it uses and manages the containers via existing networks.

A method of managing a set of containers in accordance with the present invention therefore comprises the following steps:

remote identification or recognition of the contents, via one or more communication networks, after the container is connected to one of these networks,

possible opening of the container, as a function of its state and in accordance with one of the procedures already described hereinabove, or

sending an ‘impossible to open’ message to the container or sending a signal or a message to trigger neutralization of the contents.

Each user or recipient must beforehand specify to a container manager what kind of object is to be transported and the type of network to which access is available. The manager can then identify the container to be used and initialize it in accordance with the procedure already described hereinabove.

The transportation method as already described hereinabove can then be implemented.

The monitoring system described hereinabove can be used in conjunction with a system for managing a set of transportation devices of the invention.

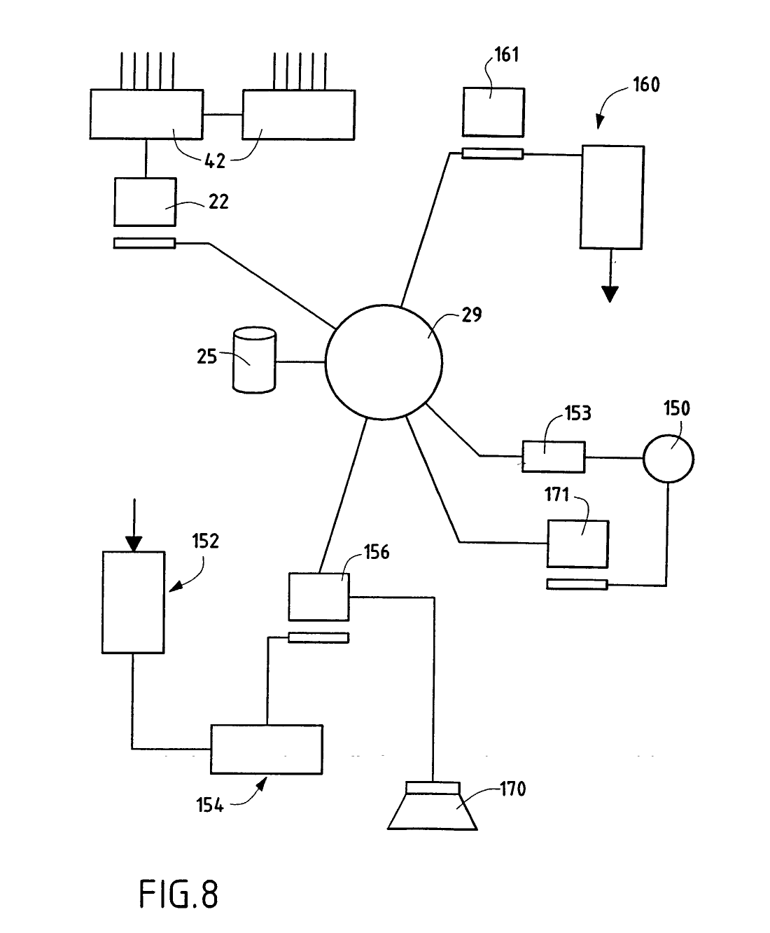

FIG. 8 shows this embodiment, in which the supervisory system (supervisor) is equipped with supervisory software on a computer local area network 29 and is connected to the local area network 150 of the management system (manager).

The reference number 22 designates a microcomputer of the monitoring system, as already described hereinabove with reference to FIGS. 2 and 3, for example, and the reference number 42 designates receiver centers, such as that already described hereinabove with reference to FIG. 4.

In practical terms, in this embodiment, the management system 150 prints out a transportation docket which is handed over to the supervisor 29.

A firewall 153 isolates the two networks.

The transportation docket issued by the manager 150 comprises, for example:

case or container number,

client code,

delivery note number, and

authorized date of opening (optional) and duration of opening.

The connection between the two networks 29 and 150 is preferably such that the transportation docket can also be entered from the network 29 if necessary.

The supervisor effects (or is specially programmed to effect) the programming of the containers and the reception of remote calls.

The supervisor can also receive and maintain cases, which services are respectively designated by the reference numbers 152 and 154 in FIG. 8.

The supervisor software stores the following information in the memory means available to the supervisor:

client data (on disc 25 from the monitoring network 29),

information on the transportation docket issued by the manager,

file of cases and shipping note in temporary state (for use by manager and supervisor),

file of delivery notes entered and not processed because of error when programming case,

file of shipping of empty cases from the center,

file of customer restarts before neutralization of the content of a transportation device,

return of case test information in local or remote mode,

information on success or failure of an attempt to open a case remotely,

nature of connection incidents (wrong jack, wrong code, wrong case, etc.),

status of a case,

state of a case,

list of cases already opened and/or disarmed and/or still on a mission,

list of operational cases ready to go,

history of operations (events),

customer connection counter.

The possible states of a container or a case can be defined as follows:

available (battery on trickle charge on rack),

on a mission (not on the monitoring system site),

on a run (remotely programmed),

opened remotely,

expected empty at center,

expected full at center,

in store on the client's premises,

“theft” code,

“loss” code,

battery on charge,

undergoing maintenance,

undergoing factory repair.

The possible states of a container can be defined as follows:

empty/full,

open/closed,

armed/not armed,

stained/not stained,

jammed/not jammed,

good/bad temperature,

good/bad relative humidity,

mesh OK/not OK,

good/bad battery.

The supervisor can also process the following connection incidents:

wrong jack,

wrong exchange code,

wrong case code,

case not opened after three attempts.

Various procedures or steps of the above kind of system are described next by way of example.

The first procedure described is that by which cases leave the center or the monitoring system.

The manager 150 prints out the transportation docket, as defined above, and attaches it to the case or the container.

The manager starts by opening a mission entry screen (using a microcomputer or PC 171) and accesses the data processing disk of the supervisor 29.

Each parameter is then entered into the database on the disc of the supervisor 29, using any data processing means available to the manager 150.

These parameters are, for example:

operator code,

authorized opening date,

staining (more generally neutralization) date,

delivery note number,

client code number,

case number (for example read off bar code on case), and

client restart date/time before staining or neutralization of case contents.

The application software of the manager 150 requests validation of the entry screen and enters the data in a table of delivery notes, which is copied to an “Edition” table, before the case is programmed.

There is only one delivery note number awaiting programming for each case and one case for each delivery note. Any other arrangement is managed by the manager's data processor system.

The manager's operator then places the contents and the delivery note in the case, locks the case, affixes a label pertaining to the recipient and passes the case to the shipping department 160 (which has a microcomputer or PC 161).

The operator of the system 29 or the operator in the shipping department 160 connects the case to a programming line. The transaction is thereafter carried out “blind” (with no screen) as far as the operator is concerned, and is processed directly by the system 29.

The operator of the system 29 then performs the following steps:

recognition of a full case,

recognition of associated data such as delivery note number, client code and/or name and case code,

assigning a client ephemeral code (invisible),

assigning a maintenance ephemeral code (invisible),

arming the case,

autotesting the components,

turning on the diode on the case.

The operator then removes the jack and ships the case.

If a diode on the case blinks on and off quickly during programming, the case is returned to maintenance for diagnosis.

For security reasons, the ephemeral codes are not chosen from a pull-down list, but are preferably generated randomly in response to each internal or external transaction request.

Moreover, the code is encrypted to prevent telephone eavesdropping when an exchange code is set remotely through the network (for example when a full case leaves the client's premises).

Provision can also be made for shipping an empty case from the supervisory system.

Clients can then obtain an empty case, for example as a supplementary service or to replace a case found to be defective on requesting a pick-up.

The procedure used by the manager for shipping an empty case is as follows:

an operator code is entered,

a case code is generated,

an agreed staining or neutralization date is chosen,

a delivery note number is chosen from the manager's normal list,

the case is closed,

a shipping label and a delivery note are affixed to the case, and

the case is passed to the shipping department 160 of the supervisory system.

On arriving at the shipping department, and after connection by the operator of the supervisory system, the system identifies the case in its table of pending shipping notes, together with the agreed staining date, and carries out only the autotest, before turning on the diode on the case in a mode such that it remains on continuously. No ephemeral code is assigned. The operator then ships the case.

As soon as a technical anomaly is detected, for example if programming fails, the supervisor:

turns on the diode on the case in a mode in which it blinks on and off quickly,

records the anomaly in the event log,

makes an entry in a table of delivery notes entered but not processed, and

makes an entry in a table of cases which are out of service for technical reasons.

The procedure for returning case can be as follows. A case is returned to the maintenance department 154 for diagnosis. The maintenance department recovers the contents and forwards it to the manager 150 so that it can be shipped again. The manager can enter the delivery note a second time because the supervisor sees it in the file of delivery notes entered but not processed.

The maintenance department can then advise the supervisor manually of the new “undergoing maintenance” state of the case.

The maintenance department 154:

creates new case codes (new cases),

provides tools for diagnosing case malfunctions,

processes technical anomalies of cases returned from programming,

opens cases that have not been opened on the client's premises, for example after three attempts,

diagnoses opening errors of all kinds, on the client's premises or on return to the manager,

opens cases using its ephemeral code and the client's ephemeral code,

receives remote programming error alerts (for example via the network 29 and an audible alarm 170), and, where applicable, advises the client of cancellation of the mission,

carries out physical and electronic maintenance of the cases (in particular after full cases are returned to the returns department),

manages the state of cases returned to the manufacturer, and

opens cases that have been stained or neutralized.

At least one PC 156 is dedicated to maintenance operations. Receiver cards or programming cards are connected to this PC.

As a general rule, all receiving centers 42 of the monitoring system can open or program cases as a function of the available internal cards. However, a receiving center cannot open a case coming directly from programming that has not been opened under remote control on the client's premises.

The maintenance facility 154 has access to all the parameters described in the programming procedure, except for reading ephemeral codes in clear. If a case is returned directly from programming, it can therefore open the case by a trivial procedure if the case is not armed, or by exchanging the maintenance ephemeral code associated with the mission if the case is full.

The maintenance department 154 also diagnoses differences on the supervisory screen that have become apparent during processing of the case in the receiving department compared to two standard situations, which are:

case normally empty, and

case normally full.

The department 152 for receiving cases comprises only a reception center. No PC is required. The operator is called the receiver.

After connecting the case returned from the client, the supervisor analyses its condition and state.

Various situations can arise, and these are considered in succession below (situations A-H):

A) A Normally Empty Case

The supervisor:

compares the case number with the client code and the delivery note number of the last connection, and checks that the association is correct,

determines that the case is empty,

verifies that the delivery note/client code has not been the subject of any transaction for returning the full case (in this case, the case would be classified as abnormally empty),

tests the technical elements, and

adds the case to the list of returned cases.

The diode on the case is turned on (indicating that opening is possible) and the receiver disconnects the case and sends it for battery charging so that it can be returned to circulation.

B) An Abnormally Empty Case

The case has been opened after remote programming by a third party other than the recipient.

1° The case has been stained or neutralized and the content is deemed to have been stained (probably in the absence of the recipient).

2° The case has been forced, but its content has not been neutralized because the client did not carry out the remote arming transaction before shipping (this is merely a procedural anomaly, because the case is expected to be normally empty).

3° The case has not been neutralized. It is necessary to check first whether an object of any kind has temporarily blocked the optical system dedicated to the sensor for determining that the case is full. This may have been done intentionally when loading the case. Any other cause must be the subject of a detailed investigation by the maintenance department.

C) A Normally Full Case (Typical Situation)

The supervisor:

makes a diagnosis,

reads the instructions of the last transaction,

recognizes the ephemeral code for opening the case allocated to the “authorized reception” jack to which the case is connected,

enters the case on the list of cases returned to physical stock,

turns on the diode on the case,

opens the case.

The receiver recovers the contents and passes the case to the maintenance department for technical tests and maintenance.

D) A Normally Full Case

The client has returned the full case without carrying out the arming procedure. In the reception department, the diode on the case blinks quickly on and off. Passing the case to the maintenance department enables the client's procedural error to be detected by registering the fact that the case is full.

E) A Case Returned After Failure to Open it on the Client's Premises

the supervisor recognizes a case that is abnormally full and accordingly turns on the diode in a mode such that it blinks on and off, and

the receiver transfers the case to the maintenance department for processing.

F) A Case with an External Appearance Defect

The reception department transfers the case directly to the maintenance department. More generally, all situations other than situations A) and C) cause the case to be transferred to the maintenance department.

The data processing system processes all anomalous situations.

Examples of procedural errors, and how they are dealt with, are given below (situations G and H):

G) Procedural Error Example 1

A case is returned full to the manager, instead of being shipped to client number 2 in the context of a scheduled run.

The supervisor:

diagnosis that the case is full,

does not recognize the ephemeral code associated with the shipment and the telephone jack,

turns on the diode on the case in a mode such that it blinks on and off.

The receiver passes the case to the maintenance department.

The maintenance department 154 connects the case and reads the last transaction (client code, shipper, destination of requested run, etc.) on the screen, notes the destination error and opens the case using the recipient's ephemeral code.

The maintenance department then has two options:

1° It has time to re-ship the case to the recipient.

2° The remaining time is too short to re-ship the case without risk of staining or neutralizing the contents, either because the battery is low or because the time remaining before programmed neutralization is too short. In this case, the maintenance department cancels the shipping procedure initially stored by the supervisor and locally programs another case for the end client. Finally, it modifies the state of the case manually.

H) Procedural Error Example 2

A case arrives directly at the reception department 152 without having gone to the client.

The supervisor notes error the because the case is not calling in from the programmed jack. The diode blinks on and off and the case is passed to the maintenance department 154.

The maintenance department notes that the case has not been opened using the remote procedure (the state of the case is “not open”). The maintenance department terminates the mission manually by erasing the programming. It returns the case and its contents to the manager for re-shipping with a new delivery note.

The supervisor manages all cases out on a mission and can distinguish the list of cases present at the center (available in stock+charging battery+undergoing maintenance+undergoing repair) from the list of cases out on a mission (leaving center+on run+in stock on a client's premises+lost+stolen).

To recover its cases under the best possible conditions, the system is informed:

when they must be opened before staining (opening time programmed locally or remotely),

where they are located (destination indicated when programming the case), and

when they should return (known approximately as a function of transportation problems and time in storage on client's premises).

When the cases should return is random because of the very nature of the procedure (with no flow control constraints for the client). Where they are located is uncertain because the destination of the cases is known only until some external event determines otherwise (loss, theft, request for pick-up, etc.). To prevent the client forgetting to open a case, the client can reset when it must be opened before staining or neutralization.

Some case state are modified automatically during a transaction (e.g. from “awaited at center” to “on run”). Other state are filled in manually by the maintenance department (lost, stolen, being processed, etc.).

The procedure whereby a full case travels from one client to another without passing through the center or the supervisor can be as follows (this refers to a circulation or a run of the case):

The client advises a server defined by the manager (using a Minitel terminal, voice-guided telephone call, etc.).

The supervisor 29 recovers the following information from the server, whose authenticity is guaranteed by the manager:

sending client code,

receiving client code,

delivery note number or equivalent,

case code,

scheduled connection date/time, and

limit opening date to be programmed.

The supervisor 29 changes the state of the case, from “expected full” to “on run”.

When client has filled and closed (locked) the case he connects it to his authorized telephone jack.

The case then calls the supervisor 29.

The supervisor recognizes the case number and accepts/refuses the transaction as a function of the state of the case (lost, stolen) or a connection incident, where applicable (case connected to wrong jack).

A diode can be turned on in a mode such that it blinks on and off slowly to indicate acceptance of the transaction.

The supervisor associates this connection with the request made by the client to the server (see above), tests the technical elements of the case (battery, case full sensor circuit, etc.) and sends the encrypted ephemeral code of the run and the encrypted maintenance ephemeral code associated with the run.

The case is then armed.

At the end of the transaction, the diode remains on to signal a correct transaction. In this situation there is no time limit for turning on the diode, as in the situation of a request for remote opening of a full case, for example.

As soon as the diode stops blinking on and off, the client can unplug the case from the jack. The client fixes the delivery note to the case and ships it himself.

If an anomaly arises during the above process, in particular during the technical tests (battery empty, etc.) or because of a procedural error (incorrect code), the diode begins and continues to blink on and off. The maintenance department then advises the client of a technical problem. To this end, an audible alarm is sounded in the maintenance department as soon as the anomaly arrives via the network 29.

To recover the contents of his case before sending it back empty, the client must disconnect the case. In this situation the supervisor delivers an instruction for opening the case, which has not been armed. If the case does not open and the diode is blinking on and off rapidly, the client then follows standing instructions for secure return of the case.

No account is intentionally taken of any particular state of the case during its remote programming for a run. In particular, a run is not prohibited if it is not the first or last delivery to the client or if the case has been declared stolen.

On the other hand, the case must have been opened the last time by the sending client. The transaction will therefore be refused on the usual terms if the case comes from a third party who has stored it but is not the client or the recipient.

The physical limit on a run by a case is tied to the battery charge. Some clients may be authorized to use a fast battery charger to charge the battery with the lid of the case open.

Finally, the state of a case which is with the client but has not yet been programmed for a run is that of a case expected at the center or by the supervisor.

The program instructions for implementing any of the embodiments described above of a method of the invention are stored in a memory area of the monitoring system 22 and/or 29 and where applicable of the manager system 150. For example, the instructions are loaded from a medium on which they are stored and that can be read by the data processing system 22 and/or 29. This medium can be a hard disk, for example, a read-only memory (ROM), a CD-ROM, a dynamic random access memory (DRAM) or any other type of RAM, a magnetic or optical storage element, registers or other volatile and/or nonvolatile memories.

Computer program instructions for implementing a monitoring method of the invention and/or a transportation method of the invention are stored in this way.

In one embodiment of the invention, a monitoring system of the invention further comprises means for receiving, or specifically programmed to receive, a signal requesting communication sent by the container when it is connected to the communication network.

According to another aspect of the invention, in a secure transportation method of the invention, a communication error signal is sent to the means which contain the object if no call is set up after connecting said means to the communication network.

Finally, in a monitoring method of the invention, the closed container can send a signal to the monitoring means 22 in the event of failure to open the container after reception by the container of the opening signal sent by the monitoring means 22.

1. A device (2, 48, 50, 52, 54, 60) for the secure transportation of an object (3), which device is characterized in that it comprises:
means (4, 6, 78, 80) for containing an object (3) to be transported, also known as a container, and closure means (6, 8, 10, 14, 82, 84, 90) for closing said means (4, 6, 78, 80) for containing an object or container,
communication means (16, 18) for connecting the means for containing an object or container to a communication network (20) and for sending over the communication network (20) a signal relating to a state of the means for containing said object or container, and
receiver means (16, 18) for receiving a signal for opening the means for closing the means for containing the object.

2. A device according to claim 1, wherein the communication means (16, 18) are adapted to send an encoded or encrypted signal relating to a state of the means for containing said object.

3. A device according to claim 1 or claim 2, comprising means (18, 62, 74, 76, 92, 94, 96, 100) for identifying or detecting a normal or abnormal operating state and/or for identifying or detecting an attempt at breaking into, violating or opening without authorization the transportation device or its closure means or a type of attempt at breaking into, violating or opening without authorization the transportation device or its closure means.

4. A device according to any one of claims 1 to 3, further comprising means (94) for sensing or measuring the temperature of the atmosphere around the container or in the container and/or means for sensing or measuring the relative humidity of said surrounding atmosphere or in said surrounding atmosphere.

5. A device according to any one of claims 1 to 4, further comprising a conductive circuit or a conductive mesh (92) inside the secure transportation device and means (18, 100) for detecting interruption of said circuit or said mesh.

6. A device according to any one of claims 1 to 5, further comprising means (62, 70, 72) for destroying or spoiling or staining an object contained in the means (4, 6, 78, 80) for containing an object.

7. A device according to any preceding claim, further comprising means for determining the location of the device during its transportation.

8. A device according to claim 8, further comprising means for sending and receiving radio frequency signals.

9. A device according to any one of claims 1 to 8, wherein the communication means comprise means (16, 114, 116) for connecting it to a telephone network.

10. A device according to any one of claims 1 to 9, wherein the communication means are adapted to dial automatically an identification number of a remote terminal, device or station also connected to the communication network after the transportation device is connected to the network.

11. A device according to claim 10, wherein the communication means are adapted or programmed to dial said identification number automatically several times if no opening signal is received or if no call is set up after connecting the communication means to the network.

12. A device according to any one of claims 1 to 11, further comprising first electrical power supply means (119) for supplying electrical power to the communication means and/or the receiver means.

13. A device according to claim 12, further comprising second electrical power supply means (124) for supplying power to the communication means in the event of dysfunction or malfunction of the first power supply means (119).

14. A device according to any one of claims 1 to 13, wherein the container has the format of a mailing envelope or parcel.

15. A device according to any one of claims 1 to 14, wherein the container has walls made of a flexible material or rubber.

16. A device according to any one of claims 1 to 15, further comprising memory means (102).

17. A device according to any one of claims 1 to 16, further comprising display means (130).

18. A system (22) for monitoring the secure transportation of an object (3) contained in a closed container (4, 6, 78, 80), which system is characterized in that it comprises:
means (22) adapted to be connected to a communication network (20) to receive a signal relating to a state of the container, and
means (22, 30, 32) for sending, or specially programmed to send, an opening signal to the container after receiving, and as a function of, the signal relating to the state of the container.

19. A system according to claim 18, further comprising means for sending, or specially programmed to send, a signal for the destruction, potting or staining of the object contained in the container if the signal relating to the state of the container that is received indicates that the container has been forced or is being forced or violated or attacked by an external agent or that the container is still closed after a predetermined closure time.

20. A system according to claim 19, further comprising means for arming beforehand, or specially programmed to arm beforehand, means (18, 62, 70, 72) for destroying, staining or potting the object contained in the container.

21. A system according to claim 20, adapted to be connected to a local communication line to arm the means for destroying, staining or potting the object.

22. A system according to any one of claims 18 to 21, further comprising means for initializing, or specially programmed to initialize, communication with the container when the container is connected to the communication network.

23. A system according to any one of claims 18 to 22, further comprising means for receiving, or specially programmed to receive, a call request signal sent by the container when the container is connected to the communication network.

24. A system according to any one of claims 18 to 23, further comprising means (30, 32) for storing in memory an identification code of a recipient of the transported object and for comparing a received identification code with this identification code of the recipient of the object.

25. A system according to any one of claims 18 to 23, further comprising means (30, 32) for storing in memory the identification or an identification code of the container and for comparing said code or said identification with the code or the identification of a container for a given recipient of the transported object.

26. A monitoring system according to any one of claims 18 to 23, further comprising means for sending and receiving radio frequency signals.

27. A method for the secure transportation of an object (3), characterized in that it comprises:
loading the object (3) into means (4, 6, 78, 80) for containing said object and closing said means,
transporting said object (3) and the means (4, 6, 78, 80) that contain it to a first predetermined recipient,
connecting the means (4, 6, 78, 80) that contain the object to a communication network (20), and
sending over said communication network a signal relating to the state of the means that contain the object.

28. A method according to claim 27, further comprising receiving a signal for opening the means that contain the object when the signal relating to the state of the means that contain the object sent by the container indicates that it is in a predetermined normal state.

29. A method according to claim 27 or 28, including, before the transportation step, a preliminary step of arming means (18, 62) for destroying, staining or potting the object contained in the container.

30. A method according to claim 29, further comprising destroying or staining of the object contained in the container if the signal relating to the state of the means that contain the object sent by the container indicates that it is in a state other than the predetermined normal state, or that it has been forced or is being forced, or has been attacked or is being attacked, by an external agent, or that the container is still closed after a predetermined closure time.

31. A method according to any one of claims 27 to 30, wherein the communication network is a telephone network.

32. A method according to claim 31, wherein the communication network is an analog telephone network.

33. A method according to any one of claims 27 to 30, wherein the communication network is an electronic communication network.

34. A method according to any one of claims 27 to 33, wherein a communication error signal is sent to the means that contain the object if no call is set up after connecting said means to the communication network.

35. A method according to any one of claims 27 to 34 including, after the means that contain the object are connected to the communication network (20), sending a signal identifying the recipient who has actually received the object (3) and the container.

36. A method according to claim 35, further comprising sending a signal identifying the means for containing the object.

37. A method according to any one of claims 27 to 36, including a preliminary step of storing an identification code of at least one recipient of the container to be transported in memory in a data processing system.

38. A method according to any one of claims 27 to 37, wherein a plurality of recipients of the container to be transported are predetermined beforehand or a plurality of identification codes of a plurality of recipients of the container are stored in memory beforehand.

39. A method according to any one of claims 27 to 38, including, after the container is opened, closing the means (4, 6, 78, 80) for containing the same object or another object and:
transporting said object (3) and the means (4, 6, 78, 80) that contain it to a second recipient,
connecting the means (4, 6, 78, 80) that contain the object to a communication network (20), and
sending over said communication network a signal relating to the state of the means that contain the object.

40. A method of monitoring the secure transportation of an object (3) contained in a closed container (4, 6, 78, 80), which method is characterized in that it-comprises:
means (22) connected to a communication network (20) receiving a signal relating to a state of the container after connection of said container to said network, and
sending an opening signal to the container after receiving the signal relating to the state of the container.

41. A method of monitoring the secure transportation of an object (3) contained in a closed container (4, 6, 78, 80), which method is characterized in that it comprises:
means (22) connected to a communication network (20) receiving a signal relating to a state of the container after connection of said container to said network,
neutralizing, destroying, staining or potting the object (3) contained in the container if the signal relating to a state of the container sent by the container indicates that the container has been, or is being, forced, violated or attacked by an external agent or that the container is still closed after a predetermined closure time.

42. A monitoring method according to claim 40 or claim 41, including a preliminary step of arming the security means for neutralizing, destroying, spoiling, staining or potting the object (3) contained in the container.

43. A method according to claim 42, wherein the preliminary step of arming the security means is executed by the means (22) connected to the communication network (20).

44. A method according to claim 43, wherein the means (22) adapted to be connected to a communication network are also adapted to be connected to a local communication network (56) and the preliminary step of arming the security system is executed via said local communication network after connection of the container to said local communication network.

45. A monitoring method according to any one of claims 42 to 44, including disarming said security means if the signal relating to the state of the container indicates that the state of the container is satisfactory.

46. A monitoring method according to claim 45, wherein the security system is re-armed after disarming it if the container is not opened after disarming the security system.

47. A method according to claim 45 or claim 46, wherein said security system is disarmed by the monitoring means (22) sending a signal to command disarming over the communication network (20) after connection of the closed container to said network.

48. A monitoring method according to any one of claims 40 to 46, further comprising the closed container sending a signal to the monitoring means (22) in the event of a container opening error after the container receives the opening signal sent by the monitoring means (22).

49. A method according to any one of claims 40 to 48, wherein the means (22) adapted to be connected to a communication network compare a signal or code identifying the recipient who has actually received the container, or the place in which the container is located, with a signal identifying an intended recipient of the container or a location to which the container is intended to be sent or transported.
